(19) United States
(12) Patent Application Publication
(10) Pub. No.: US 2017/0154365 A1
(43) Pub. Date: Jun. 1, 2017

(54) DIGITAL MEDIA DELIVERY DEVICE, METHOD, AND PROGRAM THAT SELECT DIGITAL MEDIA FOR DISPLAY WITHIN DIGITAL CONTENT BASED ON A DEGREE OF RELIABILITY OF AN EVALUATION VALUE FOR THE DIGITAL MEDIA

(71) Applicant: YAHOO JAPAN CORPORATION, Tokyo (JP)

(72) Inventors: Seira NAKAMURA, Tokyo (JP); Takuya NOMURA, Tokyo (JP); Hiroki SHIMORA, Tokyo (JP)

(73) Assignee: YAHOO JAPAN CORPORATION, Tokyo (JP)

(21) Appl. No.: 15/264,212

(22) Filed: Sep. 13, 2016

(30) Foreign Application Priority Data
Nov. 27, 2015 (JP) 2015-232368

(51) Int. Cl. G06Q 30/02; H04L 29/08

(52) U.S. Cl. CPC G06Q 30/0275; H04L 67/10; G06Q 30/0269; H04N 21/812

(57) ABSTRACT

Digital media delivery devices, methods, and programs select digital media for display within digital content on a terminal device based on a degree of reliability of an evaluation value for the digital media. The devices, methods, and programs access a memory that stores digital media information for a plurality of items of digital media including an evaluation value, and a degree of reliability that reflects the reliability of the evaluation value. The devices, methods, and programs, receive a request for digital media for display within digital content on the terminal device via the network interface, identify a group of the plurality items of digital media each having the degree of reliability above a predetermined threshold, select an item of digital media from the identified group having a highest evaluation value, and transmit an identification of the selected item of digital media via the network interface.

### CROSS-REFERENCE TO RELATED APPLICATION(S)

The present application claims priority to and incorporates by reference the entire contents of Japanese Patent Application No. 2015-232368, filed in Japan on Nov. 27, 2015.

### BACKGROUND

1. Related Technical Fields

Related technical fields include digital media delivery devices, a methods, and programs.

2. Description of the Related Art

In these years, methods are known for delivering advertisements through a predetermined advertisement delivery platform. Known examples of the advertisement delivery platform include, but are not limited to, a supply side platform (SSP) that maximizes a profit on the side of media. For example, in response to a request for bid from the SSP, each device for delivering advertisements submits a bid for an advertisement that the device intends to deliver. In this case, each device selects an advertisement to be submitted as a bid based on a certain evaluation value, such as a predicted expected profit value.

### SUMMARY

Conventional techniques mentioned above have, however, difficulty in appropriately selecting the advertisement to be submitted as a bid in a network environment. For example, if an advertisement with an insufficiently reliable evaluation value is included, an appropriate advertisement sometimes fails to be selected. In such cases, for example, it is highly likely that the advertisement to be submitted as a bid fails to be appropriately selected, and the possibility of making, for example, an expected profit is more difficult.

It is an object of exemplary embodiments of the broad inventive principles described herein to at least partially solve these computer-network-specific problems.

Exemplary embodiments provide digital media delivery devices, methods, and programs that select digital media for display within digital content on a terminal device based on a degree of reliability of an evaluation value for the digital media. The devices, methods, and programs access a memory that stores digital media information for a plurality of items of digital media, the digital media information for each item of digital media including an evaluation value, and a degree of reliability that reflects the reliability of the evaluation value. The devices, methods, and programs, receive a request for digital media for display within digital content on the terminal device via the network interface, identify a group of the plurality items of digital media each having the degree of reliability above a predetermined threshold, select an item of digital media from the identified group having a highest evaluation value, and transmit an identification of the selected item of digital media via the network interface in response to the request.

### BRIEF DESCRIPTION OF THE DRAWINGS

FIG. 1 is a diagram illustrating an example of selection processing according to an embodiment;

FIG. 2 is a diagram illustrating a configuration example of an advertisement delivery device according to the embodiment;

FIG. 3 is a diagram illustrating an example of an advertisement information storage unit according to the embodiment;

FIG. 4 is a diagram illustrating a configuration example of a terminal device according to the embodiment;

FIG. 5 is a flowchart illustrating an example of the selection processing according to the embodiment;

FIG. 6 is a sequence diagram illustrating an example of processing to display an advertisement according to the embodiment;

FIG. 7 is a diagram illustrating an example of selection processing according to Modification 1 of the embodiment;

FIG. 8 is a diagram illustrating a configuration example of an advertisement delivery device according to Modification 1;

FIG. 9 is a diagram illustrating an example of an advertisement information storage unit according to Modification 1;

FIG. 10 is a flowchart illustrating an example of the selection processing according to Modification 1;

FIG. 11 is a diagram illustrating a configuration example of an advertisement delivery device according to Modification 2 of the embodiment;

FIGS. 12A and 12B are diagrams illustrating examples of lower limit values according to Modification 2;

FIG. 13 is a diagram illustrating an example of calculation of the lower limit values according to Modification 2;

FIG. 14 is a flowchart illustrating an example of selection processing according to Modification 2; and

FIG. 15 is a hardware configuration diagram illustrating an example of a computer for carrying out functions of the advertisement delivery device.

### DETAILED DESCRIPTION OF THE EXEMPLARY EMBODIMENTS

The following describes an embodiments of a selection device, a selection method, and a selection program with reference to the drawings. The embodiments need not limit the scope of the broad inventive principles. In the following embodiments, the same portions will be assigned with the same reference numerals, and descriptions thereof will not be repeated.

### 1. Selection Processing

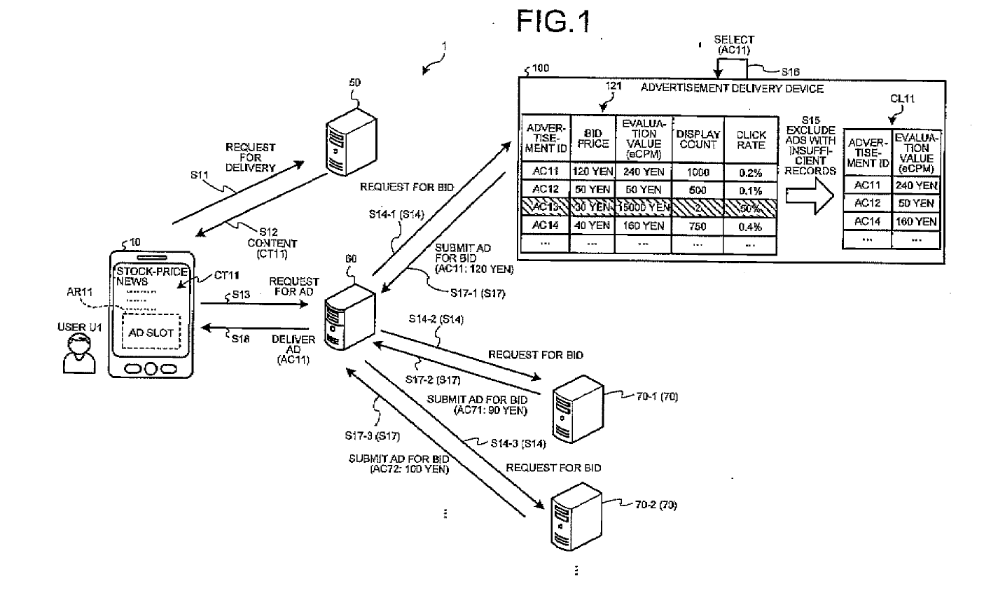

Selection processing according to an embodiment will first be described. FIG. 1 is a diagram illustrating an example of the selection processing according to the embodiment. While the following describes content CT11 serving as a web page as an example of a medium including digital media display area, such as an advertisement display area AR11 (hereinafter, called “area AR11” in some cases), the medium may be a medium other than the web page. The medium may be, for example, a medium displayed by game applications, book browsing applications, music delivery applications, and video delivery applications. The following illustrates a case in which a device 60 (hereinafter, called “SSP device 60”) used on a predetermined advertisement delivery platform delivers an advertisement submitted as a bid from each device, such as an advertisement delivery device 100, to a terminal device 10. FIG. 1 illustrates a case in which an effective cost per mille (eCPM) is used as an evaluation value for the advertisement. The evaluation value for the advertisement may be, for example, a click-through rate (CTR), a cost per click (CPC), or a conversion rate (CVR), instead of the eCPM. FIG. 1 illustrates a case of using information on the number of deliveries (hereinafter, called the “recorded number of deliveries” in some cases) of advertisements as information on a degree of reliability of the eCPM serving as the evaluation value.

As illustrated in FIG. 1, a delivery system 1 according to the embodiment includes the terminal device 10, a content delivery device 50, the SSP device 60, and the advertisement delivery device 100. The terminal device 10, the content delivery device 50, the SSP device 60, and the advertisement delivery device 100 are connected through a predetermined network so as to be capable of communicating with one another. The delivery system 1 includes, in addition to the advertisement delivery device 100, other devices 70-1, 70-2, and so on (hereinafter, called “third-party device 70-1” and so on) that submit bids for advertisements. Hereinafter, the third-party devices 70-1, 70-2, and so on will be referred to as third-party devices 70 when described without distinction. The delivery system 1 illustrated in FIG. 1 may include a plurality of such terminal devices 10, a plurality of such content delivery devices 50, a plurality of such SSP devices 60, and a plurality of such advertisement delivery devices 100.

The terminal device 10 is an information processing device used by a user. The terminal device 10 is provided, for example, as a smartphone, a tablet computer, a laptop personal computer (PC), a desktop PC, a mobile phone, or a personal digital assistant (PDA).

The content delivery device 50 is an information processing device for delivering content. In the example illustrated in FIG. 1, in response to a request from the terminal device 10, the content delivery device 50 delivers content that serves as a web page displayed on a browser started on the terminal device 10.

The SSP device 60 provides an advertisement delivery service for delivering an advertisement in response to an advertisement request. For example, the SSP device 60 requests the advertisement delivery device 100 and the third-party devices 70 to submit bids for an advertisement to be delivered in response to an advertisement request from the terminal device 10.

The advertisement delivery device 100 is a selection device that selects, from advertisements, an advertisement to be submitted as a bid in response to the request from the SSP device 60 based on the evaluation value for a delivery record of each of the advertisements and information on the degree of reliability of the evaluation value. In FIG. 1, the advertisement delivery device 100 selects an advertisement to be submitted as a bid in response to a request from the predetermined advertisement delivery platform from the advertisements except advertisements each having a record of being delivered a number of times lower than a predetermined threshold.

The following describes an example of the selection processing, using FIG. 1. The example depicted in FIG. 1 illustrates a case in which the user is a user identified by a user ID “U1” (hereinafter, called “user U1” in some cases).

As illustrated in FIG. 1, the terminal device 10 transmits a delivery request of content to the content delivery device 50 (Step S11). The terminal device 10 transmits the delivery request of content to the content delivery device 50, for example, in response to an operation by the user U1.

After receiving the delivery request from the terminal device 10, the content delivery device 50 delivers the content to the terminal device 10 (Step S12). In the example illustrated in FIG. 1, the content delivery device 50 delivers the content CT11 to the terminal device 10. In the example illustrated in FIG. 1, the content CT11 delivered by the content delivery device 50 includes a news article on stocks and the area AR 11.

After receiving the content CT11 including the advertisement display area AR11, the terminal device 10 transmits an advertisement request requesting an advertisement to be displayed in the advertisement display area AR11 included in the received content CT11 to the SSP device 60 (Step S13).

After acquiring the advertisement request from the terminal device 10, the SSP device 60 requests the advertisement delivery device 100, the third-party devices 70, and so on to submit bids for the advertisement (Step S14). Specifically, the SSP device 60 requests the advertisement delivery device 100 to submit a bid for the advertisement (Step S14-1), requests the third-party device 70-1 to submit a bid for the advertisement (Step S14-2), and requests the third-party device 70-2 to submit a bid for the advertisement (Step S14-3), Steps S14-1 to S14-3 may differ in timing.

After acquiring the request for bid on the advertisement from the SSP device 60, the advertisement delivery device 100 selects an advertisement to be submitted as a bid based on the recorded number of deliveries and the eCPM serving as the evaluation value for the delivery record of each of the advertisements. Specifically, the advertisement delivery device 100 selects the advertisement to be submitted as a bid from an advertisement group excluding the advertisements each having a record of being delivered a number of times lower than the predetermined threshold. That is, the advertisement delivery device 100 selects the advertisement to be submitted as a bid excluding advertisements each having a record of being delivered a number of times not reaching the predetermined threshold, that is, excluding advertisements each having a low degree of reliability of the eCPM serving as the evaluation value. In this manner, the advertisement delivery device 100 selects, from the advertisements, the advertisement to be submitted as a bid in response to the request from the SSP device 60 based on the degree of reliability of the evaluation value.

In FIG. 1, the advertisement delivery device 100 selects the advertisement and so on to be submitted as a bid from advertisements identified by advertisement IDs “AC11” to “AC14” (hereinafter, called “advertisement AC11” and so on in some cases). In FIG. 1, the advertisement delivery device 100 uses the number of times of delivery (display) of each advertisement as the recorded number of deliveries. The advertisement delivery device 100 selects the advertisement to be submitted as a bid from an advertisement group excluding advertisements each having a record of being delivered less than 100 times.

That is, the advertisement delivery device 100 excludes advertisements having insufficient records (Step S15). In FIG. 1, the recorded number of deliveries of the advertisement AC13 is less than 100, so that the advertisement delivery device 100 excludes the advertisement AC13 from advertisements to be submitted as bids. The advertisement delivery device 100 selects the advertisement to be submitted as a bid from an advertisement group CL11 excluding the advertisements having insufficient records (Step S16). In FIG. 1, the advertisement delivery device 100 selects the advertisement AC11 having the highest eCPM as the evaluation value, as the advertisement to be submitted as a bid. The advertisement delivery device 100 then submits the selected advertisement AC11 as a bid to the SSP device 60 (Step S17-1 (S17)). For example, the advertisement delivery device 100 transmits information on (such as a bid price for) the selected advertisement AC11 to the SSP device 60.

Each of the third-party devices 70 that has acquired the request for bid at Step S14 also submits an advertisement as a bid to the SSP device 60 (Step S17). Specifically, the third-party device 70-1 submits an advertisement AC71 as a bid to the SSP device 60 (Step S17-2), and the third-party device 70-2 submits an advertisement AC72 as a bid to the SSP device 60 (Step S17-3).

After receiving the bids for the advertisements from the advertisement delivery device 100 and the third-party devices 70 at Step S17, the SSP device 60 delivers an advertisement determined according to a predetermined criterion from among the received advertisements to the terminal device 10 (Step S18). In FIG. 1, the SSP device 60 delivers the advertisement AC11 for which the bid price is the highest to the terminal device 10.

After receiving the advertisement AC11 from the SSP device 60, the terminal device 10 displays the advertisement AC 11 in the area AR11 of the content CT11. For simplicity of explanation, FIG. 1 illustrates the example in which the SSP device 60 delivers the advertisement to the terminal device 10. However, the advertisement may be delivered to the terminal device 10 by the advertisement delivery device 100 or any one of the third-party devices 70 that has submitted, as a bid, the advertisement determined to be the advertisement to be delivered to the terminal device 10. That is, the SSP device 60 only needs to determine the advertisement to be delivered to the terminal device 10, and another device may deliver the advertisement. For example, to deliver the advertisement to the terminal device 10, the SSP device 60 may notify a predetermined advertisement delivery platform, such as a demand-side platform (DSP), other than the SSP device 60 of the advertisement to be delivered, and the predetermined advertisement delivery platform notified of the advertisement may deliver the advertisement. In this manner, the SSP device 60 need not deliver the advertisement to the terminal device 10, while being used only for determining the advertisement to be delivered to the terminal device 10. That is, any device can deliver the advertisement to the terminal device 10.

As described above, the advertisement delivery device 100 selects the advertisement to be submitted as a bid in response to the request from the SSP device 60 based on the recorded number of deliveries and the evaluation value for the delivery record of each of the advertisements. Specifically, the advertisement delivery device 100 selects the advertisement to be submitted as a bid in response to the request from the SSP device 60 from the advertisement group excluding advertisements each having a record of being delivered a number of times lower than the predetermined threshold based on the recorded number of deliveries and the evaluation value for the delivery record of each of the advertisements. Thereby, the advertisement delivery device 100 can appropriately select the advertisement to be submitted as a bid. For example, if the advertisement delivery device 100 selects the advertisement to be submitted as a bid without excluding the advertisement having an insufficient record (advertisement AC13 in FIG. 1), the advertisement delivery device 100 may select the advertisement AC13 having the highest eCPM in some cases. In FIG. 1, the recorded number of deliveries of the advertisement AC13 is 2, so that the degree of reliability of the eCPM is low. Hence, delivering the advertisement AC13 is likely to fail in making a profit indicated by the eCPM. Due to this, the advertisement delivery device 100 is likely to fail in making a predicted profit. That is, the advertisement delivery device 100 can increase the possibility of making the profit indicated by the eCPM by excluding the advertisements having insufficient records. The above example has illustrated the case in which the information on the number of deliveries of each of the advertisements AC is used as the information on the degree of reliability of the eCPM serving as the evaluation value. However, various types of information may be appropriately selected as the information on the degree of reliability of the eCPM depending on the purpose. For example, the advertisement delivery device 100 may use, for example, information on user behaviors, such as clicks on each of the delivered advertisements, and/or information on date and time of start of delivery of each of the advertisements, as the information on the degree of reliability of the eCPM.

### 2. Configuration of Advertisement Delivery Device

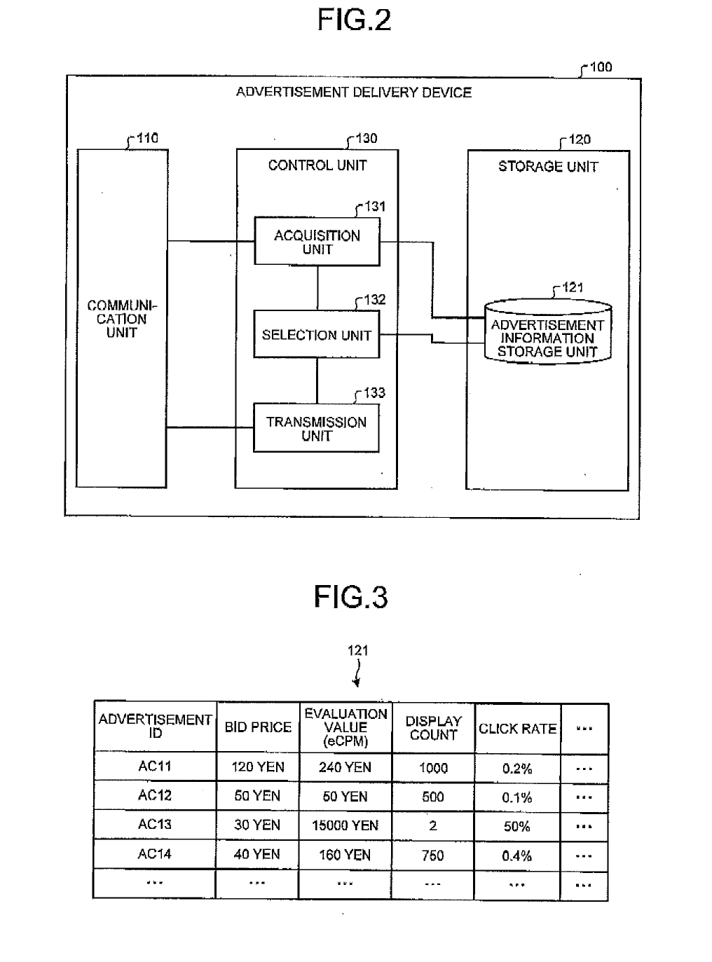

The following describes the configuration of the advertisement delivery device 100 according to the embodiment with reference to FIG. 2. FIG. 2 is a diagram illustrating a configuration example of the advertisement delivery device 100 according to the embodiment. As illustrated in FIG. 2, the advertisement delivery device 100 includes a communication unit 110, a storage unit 120, and a control unit 130. The advertisement delivery device 100 may include an input unit (for example, a keyboard, a mouse, etc.) that receives various operations from, for example, an administrator of the advertisement delivery device 100, and may include a display unit (such as a liquid crystal display) for displaying various types of information.

The communication unit 110 is provided, for example, using a network interface card (NIC). The communication unit 110 is connected in a wired or wireless manner to the network, and transmits and receives information to and from the terminal device 10.

The storage unit 120 is provided using a storage medium, for example, a semiconductor memory device, such as a random access memory (RAM) or a flash memory, or a storage device, such as a hard disk or an optical disc. (As used herein the term “storage medium” is not intended to encompass transitory signals.) The storage unit 120 according to the embodiment includes an advertisement information storage unit 121, as illustrated in FIG. 2.

The advertisement information storage unit 121 according to the embodiment stores various types of information on advertisements. FIG. 3 illustrates an example of the advertisement information storage unit 121 according to the embodiment. The advertisement information storage unit 121 illustrated in FIG. 3 includes items such as “advertisement ID,” “bid price,” “evaluation value (eCPM),” “display count,” and “click rate.”

The item “advertisement ID” represents identification information for identifying each of the advertisements. The item “bid price” represents an advertising fee that an advertiser specifies when submitting the advertisement. The item “bid price” corresponds to, for example, a unit price paid by the advertiser to an advertisement distributor (such as an administrator of the SSP device 60 or the advertisement delivery device 100) when the advertisement is clicked once by a user. The item “evaluation value (eCPM)” represents the evaluation value for the advertisement. The item “display count” represents the number of times the advertisement has been displayed. The item “display count” represents, for example, the number of times the advertisement has been delivered to the terminal device 10. The item “click rate” represents the CTR, representing a value obtained by dividing the number of times of clicking of the advertisement by the display count of the advertisement.

For example, the example illustrated in FIG. 3 indicates that the advertisement AC11 has a bid price of “120 yen,” an eCPM as an evaluation value of “240 yen,” a display count of “1000” times, and a click rate of “0.2%.” For example, the example illustrated in FIG. 3 indicates that the advertisement AC12 has a bid price of “50 yen,” an eCPM as an evaluation value of “50 yen,” a display count of “500” times, and a click rate of “0.1%.”

The advertisement information storage unit 121 may store various types of information depending on the purpose in addition to the information described above. For example, the advertisement information storage unit 121 stores advertisement content (simply called “advertisements” in some cases) submitted by advertisers. Specifically, the advertisement information storage unit 121 stores, for example, static images, moving images, text data, and Uniform Resource Locators (URLs), or file path names indicating storage locations of these pieces of data. For example, the advertisement information storage unit 121 may store identification information for identifying the advertisers. Since an advertiser may entrust an agent to perform a submitting operation in some cases, the expression “advertiser” is a concept including not only an advertiser but also an agent. The advertisement information storage unit 121 may store, for example, information indicating a name of a product or a name of a service to be advertised in the corresponding advertisement. The advertisement information storage unit 121 may store, as information indicating each product or the like, information such as a “product ID” for identifying a product, not limited to the “name of the product.”

Coming back to the explanation of FIG. 2, the control unit 130 is implemented, for example, by a central processing unit (CPU) or a microprocessor unit (MPU) that executes various programs (corresponding to an example of the selection program) stored in a storage device in the advertisement delivery device 100 using a RAM as a work area. Alternatively, the control unit 1.30 is implemented, for example, by an integrated circuit, such as an application specific integrated circuit (ASIC) or a field programmable gate array (FPGA).

As illustrated in FIG. 2, the control unit 130 includes an acquisition unit 131, a selection unit 132, and a transmission unit 133, and implements or executes functions or operations of the selection processing to be described below. The internal configuration of the control unit 130 is not limited to the configuration illustrated in FIG. 2, but may be any other configuration as long as the selection processing to be described below is performed. The connection relation of the processing units included in the control unit 130 is not limited to the connection relation illustrated in FIG. 2, but may be another connection relation.

The acquisition unit 131 acquires the evaluation values for the delivery records of the advertisements and the information on the degrees of reliability of the evaluation values. For example, the acquisition unit 131 acquires a behavioral history of the user from the advertisement information storage unit 121. For example, the acquisition unit 131 may store the behavioral history of the user acquired from a predetermined external device or the terminal device 10 into the advertisement information storage unit 121. The acquisition unit 131 acquires a request for bid from the predetermined external device. The acquisition unit 131 may acquire the request for bid from, for example, the SSP device 60.

The acquisition unit 131 may acquire an advertisement submitted by an advertiser. The acquisition unit 131 may acquire an advertisement submitted by an agent entrusted by an advertiser to submit the advertisement. In this case, the acquisition unit 131 acquires the submitted advertisement, for example, from an information processing device used by the advertiser or the agent. For example, the acquisition unit 131 stores the acquired advertisement in the advertisement information storage unit 121.

The selection unit 132 selects, from the advertisements, an advertisement to be submitted as a bid in response to a request from the predetermined advertisement delivery platform based on the evaluation value for the delivery record of each of the advertisements and the information on the degree of reliability of the evaluation value. For example, the selection unit 132 selects, from the advertisements, the advertisement to be submitted as a bid in response to the request from the SSP device 60 based on the recorded number of deliveries and the eCPM of each of the advertisements. For example, the selection unit 132 uses the information on the numbers of deliveries of the respective advertisements, the information on the user behaviors in response to the delivered advertisements, or the information on dates and times when the advertisements started to be delivered as the information on the degrees of reliability of the evaluation values so as to select, from the advertisements, the advertisement to be submitted as a bid in response to the request from the predetermined advertisement delivery platform. For example, the selection unit 132 selects the advertisement to be submitted as a bid in response to the request from the predetermined advertisement delivery platform from the advertisements except advertisements for each of which the information on the degree of reliability of the evaluation value has a value lower than a predetermined threshold. In FIG. 1, the selection unit 132 selects the advertisement to be submitted as a bid in response to the request from the SSP device 60 from the advertisements except the advertisement AC13 that is an advertisement having a record of being delivered a number of times lower than the predetermined threshold.

The transmission unit 133 transmits information on the advertisement selected by the selection unit 132 to the SSP device 60. The transmission unit 133 transmits, for example, the advertisement selected by the selection unit 132 and the bid price for the advertisement to the SSP device 60. In FIG. 1, the transmission unit 133 transmits the information on the advertisement AC11 selected by the selection unit 132 to the SSP device 60. The transmission unit 133 may transmit the advertisement to the terminal device 10.

### 3. Configuration of Terminal Device

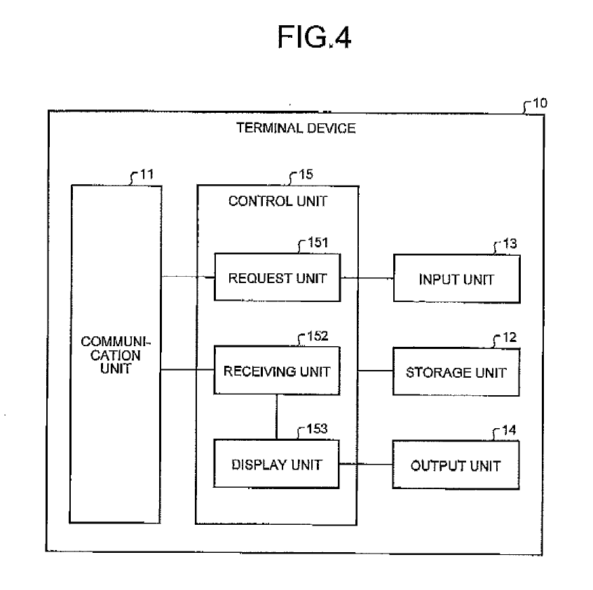

The following describes the configuration of the terminal device 10 according to the embodiment, using FIG. 4. FIG. 4 is a diagram illustrating a configuration example of the terminal device 10 according to the embodiment. As illustrated in FIG. 4, the terminal device 10 includes a communication unit 11, a storage unit 12, an input unit 13, an output unit 14, and a control unit 15.

The communication unit 11 is provided, for example, using a communication circuit. The communication unit 11 is connected in a wired or wireless manner to a certain network (not illustrated), and transmits and receives information to and from the SSP device 60 and the content delivery device 50. The communication unit 11 may transmit and receive information to and from the advertisement delivery device 100.

The storage unit 12 is provided using, for example, a semiconductor memory device, such as a RAM or a flash memory, or a storage device, such as a hard disk or an optical disc. The storage unit 12 stores, for example, information on applications, such as programs, installed on the terminal device 10.

The input unit 13 receives various operations from the user. For example, the input unit 13 may receive the various operations from the user through a display surface (such as a display unit 153) using a touchscreen panel function. The input unit 13 may receive the various operations from buttons provided on the terminal device 10 or from a keyboard and/or a mouse connected to the terminal device 10.

The output unit 14 is a display screen of, for example, a tablet computer provided using, for example, a liquid crystal display or an electroluminescent display (ELD), and is a display device for displaying various types of information.

The control unit 15 is implemented, for example, by a CPU or an MPU that executes various programs stored in a storage device, such as the storage unit 12, in the terminal device 10 using a RAM as a work area. The various programs include, for example, the programs of the installed applications. The control unit 15 is implemented, for example, by an integrated circuit, such as an ASIC or an FPGA.

As illustrated in FIG. 4, the control unit 15 includes a request unit 151, a receiving unit 152, and a display unit 153, and implements or executes functions or operations of display processing to be described below. The internal configuration of the control unit 15 is not limited to the configuration illustrated in FIG. 4, but may be any other configuration as long as the display processing to be described below is performed. The connection relation of the processing units included in the control unit 15 is not limited to the connection relation illustrated in FIG. 4, but may be another connection relation.

The request unit 151 transmits a delivery request to the content delivery device 50 according to a user operation received by the input unit 13. For example, the request unit 151 transmits the delivery request from a started application, such as a browser, to the content delivery device 50. The request unit 151 requests delivery of an advertisement from the advertisement delivery device 100 according to a user operation received by the input unit 13. For example, if content acquired from the content delivery device 50 includes an advertisement display area, the request unit 151 requests the delivery of the advertisement from the SSP device 60. For example, if the content CT11 acquired from the content delivery device 50 includes the advertisement display area AR11, the request unit 151 transmits the advertisement request to the SSP device 60.

The receiving unit 152 receives the content delivered from the content delivery device 50. For example, the receiving unit 152 receives the content CT11 including the advertisement display area AR11 from the content delivery device 50. The receiving unit 152 receives the advertisement delivered from the SSP device 60. For example, the receiving unit 152 receives the advertisement to be displayed in the advertisement display area AR11 from the SSP device 60. The receiving unit 152 may receive the advertisement from the advertisement delivery device 100 or any one of the third-party devices 70.

The display unit 153 displays the content and the advertisement received by the receiving unit 152. For example, the display unit 153 displays the content CT11, the advertisement AC11, and so on.

The above-described processing, such as the display processing, by the control unit 15 may be executed using the JavaScript (registered trademark). If the display processing described above is executed by a predetermined application or a dedicated application, the control unit 15 may include, for example, an application control unit for controlling the predetermined application or the dedicated application.

### 4. Processing Procedure

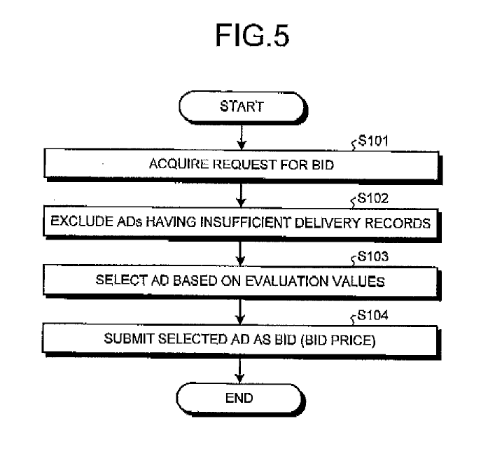

The following describes a procedure of the selection processing by the delivery system 1 according to the embodiment, using FIG. 5. FIG. 5 is a flowchart illustrating an example of the selection processing according to the embodiment.

As illustrated in FIG. 5, the acquisition unit 131 of the advertisement delivery device 100 acquires the request for bid from the predetermined advertisement delivery platform (Step S101). For example, the acquisition unit 131 acquires the request for bid from the SSP device 60.

Then, the selection unit 132 of the advertisement delivery device 100 excludes advertisements having insufficient delivery records (Step S102). In FIG. 1, the selection unit 132 excludes the advertisement AC13 having an insufficient delivery record. The selection unit 132 then selects an advertisement based on the evaluation value (Step S103). In FIG. 1, the selection unit 132 selects, based on the eCPM, the advertisement AC11 from the advertisement group CL11 excluding the advertisement AC13.

Then, the transmission unit 133 of the advertisement delivery device 100 submits, as a bid, the advertisement selected by the selection unit 132 (Step S104). In FIG. 1, the transmission unit 133 transmits the information on (such as the bid price for) the advertisement AC11 selected by the selection unit 132 to the SSP device 60.

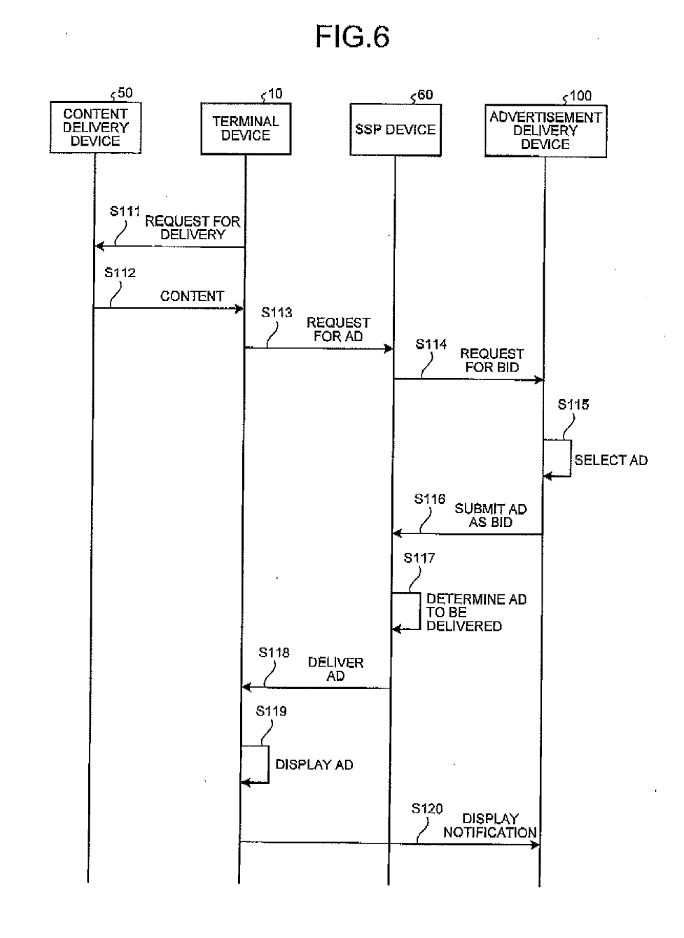

The following describes a processing procedure of the advertisement display in the delivery system 1, using FIG. 6. FIG. 6 is a sequence diagram illustrating an example of the processing to display the advertisement according to the embodiment. The sequence diagram depicted in FIG. 6 illustrates the processing involving the terminal device 10, the content delivery device 50, the SSP device 60, and the advertisement delivery device 100. That is, FIG. 6 illustrates the sequence diagram that does not include processing involving the third-party devices 70.

As illustrated in FIG. 6, the terminal device 10 transmits a delivery request of content to the content delivery device 50 (Step S111). After receiving the delivery request from the terminal device 10, the content delivery device 50 delivers the content to the terminal device 10 (Step S112).

After receiving the content, the terminal device 10 transmits an advertisement request requesting an advertisement to be displayed in an advertisement display area included in the received content, to the SSP device 60 (Step S113). After acquiring the advertisement request from the terminal device 10, the SSP device 60 requests the advertisement delivery device 100, the third-party devices 70, and so on to submit bids for the advertisement (Step S114).

After acquiring the request for bid on the advertisement from the SSP device 60, the advertisement delivery device 100 selects an advertisement to be submitted as a bid based on the recorded number of deliveries and the eCPM serving as the evaluation value for the delivery record of each of the advertisements (Step S115). The advertisement delivery device 100 then submits the selected advertisement as a bid to the SSP device 60 (Step S116). For example, the advertisement delivery device 100 transmits the information on (such as the bid price for) the advertisement selected at Step S115 to the SSP device 60.

After receiving the bids for the advertisements from the advertisement delivery device 100 and the third-party devices 70, the SSP device 60 determines an advertisement to be delivered from among the received advertisements (Step S117). The SSP device 60 then delivers the advertisement determined at Step S117 to the terminal device 10 (Step S118). For example, the SSP device 60 delivers the advertisement submitted as a bid by the advertisement delivery device 100 to the terminal device 10.

After receiving the advertisement AC11 from the SSP device 60, the terminal device 10 displays the advertisement AC11 in the area AR11 of the content CT11 (Step S119). The terminal device 10 then notifies the advertisement delivery device 100 having submitted the advertisement as a bid that the delivered advertisement has been displayed (Step S120).

### 5. Modifications

The processing to select an advertisement to be submitted as a bid is not limited to the selection processing of the embodiment described above. The selection processing may be performed based on various types of information and conditions. Thus, the following describes other types of selection processing each performed by an advertisement delivery device. The same configurations as those of the embodiment will be assigned with the same reference numerals, and descriptions thereof will not be repeated.

### A. Modification 1

i. Selection Processing

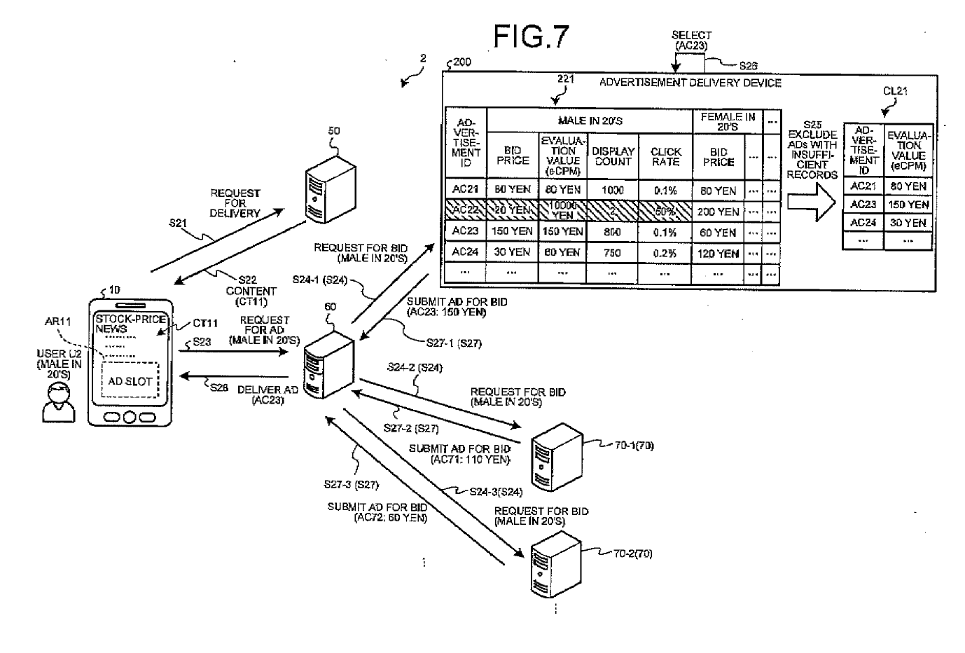

Selection processing according to Modification 1 of the embodiment will first be described. FIG. 7 is a diagram illustrating an example of the selection processing according to Modification 1. An advertisement delivery device 200 selects, from the advertisements, an advertisement to be submitted as a bid in response to the request from the SSP device 60 based on the recorded number of deliveries and the evaluation value for the delivery record of each of the advertisements relevant to a user attribute of a user as a target of delivery.

As illustrated in FIG. 7, a delivery system 2 according to Modification 1 includes the terminal device 10, the content delivery device 50, the SSP device 60, and the advertisement delivery device 200. The terminal device 10, the content delivery device 50, the SSP device 60, and the advertisement delivery device 200 are connected through a predetermined network so as to be capable of communicating with one another. The delivery system 2 includes, in addition to the advertisement delivery device 200, the third-party devices 70 that submit bids for advertisements. The delivery system 2 illustrated in FIG. 7 may include a plurality of such terminal devices 10, a plurality of such content delivery devices 50, a plurality of such SSP devices 60, and a plurality of such advertisement delivery devices 200.

The advertisement delivery device 200 is a selection device that selects, from the advertisements, the advertisement to be submitted as a bid in response to the request from the SSP device 60 based on the recorded number of deliveries and the evaluation value for the delivery record of each of the advertisements. In FIG. 7, the advertisement delivery device 200 selects, from the advertisements, the advertisement to be submitted as a bid in response to the request from the SSP device 60 based on the recorded number of deliveries and the evaluation value for the delivery record of each of the advertisements relevant to the user attribute of the user as a target of delivery.

The following describes the example of the selection processing, using FIG. 7. The example depicted in FIG. 7 illustrates a case in which the user is a user identified by a user ID “U2” (hereinafter, called “user U2” in some cases).

As illustrated in FIG. 7, the terminal device 10 transmits a delivery request of content to the content delivery device 50 (Step S21). The terminal device 10 transmits the delivery request of content to the content delivery device 50, for example, in response to an operation by the user U2.

After receiving the delivery request from the terminal device 10, the content delivery device 50 delivers the content to the terminal device 10 (Step S22). In the example illustrated in FIG. 7, the content delivery device 50 delivers the content CT11 to the terminal device 10. In the example illustrated in FIG. 7, the content CT11 delivered by the content delivery device 50 includes a news article on stocks and the area AR11.

After receiving the content CT11 including the advertisement display area AR11, the terminal device 10 transmits an advertisement request requesting an advertisement to be displayed in the advertisement display area AR11 included in the received content CT11, to the SSP device 60 (Step S23). In the example of FIG. 7, the advertisement request transmitted to the SSP device 60 by the terminal device 10 includes the user attribute of the user U2. For example, the terminal device 10 transmits the advertisement request to the SSP device 60, together with information on the user attribute of the user U2, including, for example, age group and sex. The SSP device 60 may acquire the information on the user attribute of the user U2 prior to Step S23.

After acquiring the advertisement request from the terminal device 10, the SSP device 60 requests the advertisement delivery device 200, the third-party devices 70, and so on to submit bids for the advertisement (Step S24). Specifically, the SSP device 60 requests the advertisement delivery device 200 to submit a bid for the advertisement (Step S24-1), requests the third-party device 70-1 to submit a bid for the advertisement (Step S24-2), and requests the third-party device 70-2 to submit a bid for the advertisement (Step S24-3). Steps S24-1 to S24-3 may differ in timing.

In the example of FIG, 7, when the SSP device 60 makes the request for bid, the SSP device 60 transmits the information on the user attribute of the user U2 who is a target of delivery of the advertisement, to the advertisement delivery device 200, the third-party devices 70, and so on. For example, the SSP device 60 transmits the information on the user attribute of the user U2, including, for example, age group and sex, to the advertisement delivery device 200, the third-party devices 70, and so on. The advertisement delivery device 200, the third-party devices 70, and so on may acquire the information on the user attribute of the user U2 prior to Step S24. In this case, the SSP device 60 transmits information for identifying the user U2 who is a target of delivery of the advertisement, to the advertisement delivery device 200, the third-party devices 70, and so on.

After acquiring the request for bid on the advertisement from the SSP device 60, the advertisement delivery device 200 selects an advertisement to be submitted as a bid based on the recorded number of deliveries and the eCPM serving as the evaluation value for the delivery record of each of the advertisements relevant to the user attribute of the user U2. Specifically, the advertisement delivery device 200 selects the advertisement to be submitted as a bid based on the information on the user attribute of the user U2 among pieces of information stored in an advertisement information storage unit 221.

In FIG. 7, the advertisement delivery device 200 selects the advertisement to be submitted as a bid from advertisements identified by advertisement IDs “AC21” to “AC24” (hereinafter, called “advertisement AC21” and so on in some cases). In FIG. 7, the advertisement delivery device 200 uses the number of times of delivery (display) of each advertisement as the recorded number of deliveries. The advertisement delivery device 200 selects the advertisement to be submitted as a bid from an advertisement group excluding advertisements each having a record of being delivered less than 100 times to a male in the 20's that is a user attribute to which the user U2 belongs.

That is, the advertisement delivery device 200 excludes advertisements having insufficient records (Step S25). In FIG. 7, the recorded number of deliveries of the advertisement AC22 is less than 100, so that the advertisement delivery device 200 excludes the advertisement AC22 from advertisements to be submitted as bids. The advertisement delivery device 200 selects the advertisement to be submitted as a bid from an advertisement group CL21 excluding the advertisements having insufficient records (Step S26). In FIG. 7, the advertisement delivery device 200 selects the advertisement AC23 having the highest eCPM as the evaluation value, as the advertisement to be submitted as a bid. The advertisement delivery device 200 then submits the selected advertisement AC23 as a bid to the SSP device 60 (Step S27-1 (S27)). For example, the advertisement delivery device 200 transmits information on (such as a bid price for) the selected advertisement AC23 to the SSP device 60.

Each of the third-party devices 70 that has acquired the request for bid at Step S24 also submits an advertisement as a bid, to the SSP device 60 (Step S27). Specifically, the third-party device 70-1 submits the advertisement AC71 as a bid to the SSP device 60 (Step S27-2), and the third-party device 70-2 submits the advertisement AC72 as a bid, to the SSP device 60 (Step S27-3).

After receiving the bids for the advertisements from the advertisement delivery device 200 and the third-party devices 70 at Step S27, the SSP device 60 delivers an advertisement determined according to a predetermined criterion from among the received advertisements, to the terminal device 10 (Step S28). In FIG. 7, the SSP device 60 delivers the advertisement AC23 for which the bid price is the highest, to the terminal device 10.

After receiving the advertisement AC23 from the SSP device 60, the terminal device 10 displays the advertisement AC23 in the area AR11 of the content CT11. FIG. 7 illustrates the example in which the SSP device 60 delivers the advertisement to the terminal device 10. However, the advertisement may be delivered to the terminal device 10 by the advertisement delivery device 200 or any one of the third-party devices 70 that has submitted, as a bid, the advertisement determined to be the advertisement to be delivered to the terminal device 10.

ii. Configuration of Advertisement Delivery Device

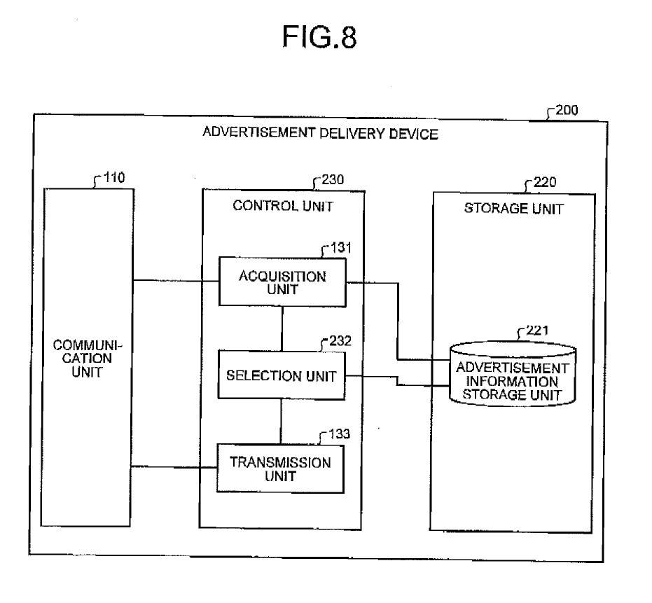

The following describes the configuration of the advertisement delivery device 200 according to Modification 1, using FIG. 8. FIG. 8 is a diagram illustrating a configuration example of the advertisement delivery device 200 according to Modification 1. As illustrated in FIG. 8, the advertisement delivery device 200 includes the communication unit 110, a storage unit 220, and a control unit 230.

The storage unit 220 is provided using, for example, a semiconductor memory device, such as a RAM or a flash memory, or a storage device, such as a hard disk or an optical disc. The storage unit 220 according to Modification 1 includes the advertisement information storage unit 221 as illustrated FIG. 8.

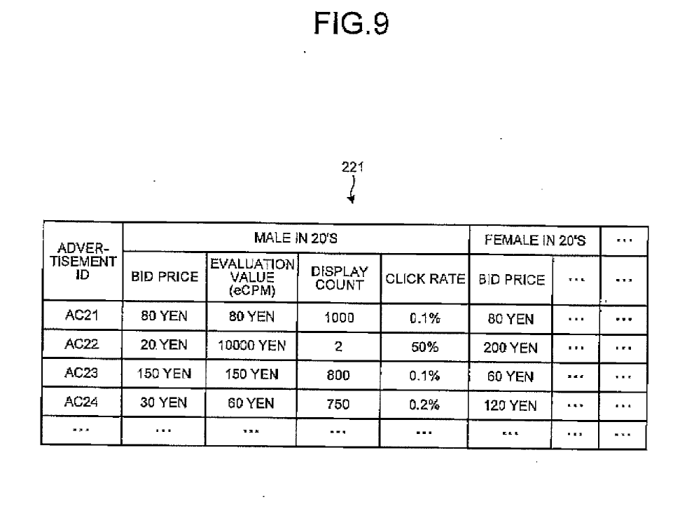

The advertisement information storage unit 221 according to Modification 1 stores various types of information on advertisements. FIG. 9 illustrates an example of the advertisement information storage unit 221 according to Modification 1. The advertisement information storage unit 221 illustrated in FIG. 9 includes items such as “advertisement ID” and items such as “bid price,” “evaluation value (eCPM),” “display count,” and “click rate” for each of the user attributes, such as “male in 20's” and “female in 20's.”

The item “advertisement ID” represents the identification information for identifying each of the advertisements. The item “bid price” represents an advertising fee that an advertiser specifies when submitting the advertisement. The item “bid price” corresponds to, for example, a unit price paid by the advertiser to an advertisement distributor (such as an administrator of the SSP device 60 or the advertisement delivery device 200) when the advertisement is clicked once by a user. The item “display count” represents the number of times the advertisement has been displayed. The item “display count” represents, for example, the number of times the advertisement has been delivered to the terminal device 10. The item “click rate” represents the CTR, representing a value obtained by dividing the number of times of clicking of the advertisement by the display count of the advertisement.

For example, the example illustrated in FIG. 9 indicates that the advertisement AC21 has a bid price of “80 yen,” an eCPM as an evaluation value of “80 yen,” a display count of “1000” times, and a click rate of “0.1%” when the user attribute is “male in 20's.” For example, the example illustrated in FIG. 9 indicates that the advertisement AC22 has a bid price of “20 yen,” an eCPM as an evaluation value of “10000 yen,” a display count of “2” times, and a click rate of “50%” when the user attribute is “male in 20's.”

The advertisement information storage unit 221 may store various types of information depending on the purpose, not limited to the information described above. For example, the advertisement information storage unit 221 may store identification information for identifying the advertisers. Since an advertiser may entrust an agent to perform a submitting operation in some cases, the expression “advertiser” is a concept including not only an advertiser but also an agent. The advertisement information storage unit 221 may store, for example, information indicating a name of a product or a name of a service to be advertised in the corresponding advertisement. The advertisement information storage unit 221 may store, as information indicating each product or the like, information such as a “product ID” for identifying a product, not limited to the “name of the product.”

Coining back to the explanation of FIG. 8, the control unit 230 is implemented, for example, by a CPU or an MPU that executes various programs (corresponding to an example of the selection program) stored in a storage device in the advertisement delivery device 200 using a RAM as a work area. Alternatively, the control unit 230 is implemented, for example, by an integrated circuit, such as an ASIC or an FPGA.

As illustrated in FIG. 8, the control unit 230 includes the acquisition unit 131, a selection unit 232, and the transmission unit 133, and implements or executes functions or operations of the selection processing to be described below. The internal configuration of the control unit 230 is not limited to the configuration illustrated in FIG. 8, but may be any other configuration as long as the selection processing to be described below is performed. The connection relation of the processing units included in the control unit 230 is not limited to the connection relation illustrated in FIG. 8, but may be another connection relation.

The selection unit 232 selects information matching a user attribute of a user as a target of delivery of the advertisement from the advertisement information storage unit 221. The selection unit 232 selects, from the advertisements, an advertisement to be submitted as a bid in response to the request from the predetermined advertisement delivery platform based on the recorded number of deliveries and the evaluation value for the delivery record of each of the advertisements relevant to the user attribute of the user as a target of delivery. For example, the selection unit 232 selects, from the advertisements, the advertisement to be submitted as a bid in response to the request from the SSP device 60 based on the recorded number of deliveries and the eCPM of each of the advertisements relevant to the user attribute of the user. For example, the selection unit 232 selects an advertisement to be submitted as a bid in response to the request by the predetermined advertisement delivery platform, from the advertisements except advertisements each having a record of being delivered a number of times lower than the predetermined threshold to users having a user attribute to which the user as a target of delivery of the advertisement belongs. In FIG. 7, the selection unit 232 selects the advertisement to be submitted as a bid in response to the request from the SSP device 60 from the advertisements except the advertisement AC22 that is an advertisement having a record of being delivered a number of times lower than the predetermined threshold to users having a user attribute to which the user as a target of delivery of the advertisement belongs.

iii. Processing Procedure

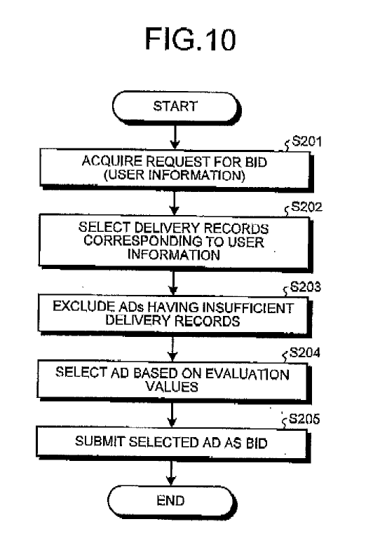

The following describes a procedure of the selection processing by the delivery system 1 according to Modification 1, using FIG. 10. FIG. 10 is a flowchart illustrating an example of the selection processing according to Modification 1.

As illustrated in FIG. 10, the acquisition unit 131 of the advertisement delivery device 200 acquires the request for bid from the predetermined advertisement delivery platform (Step S201). The acquisition unit 131 acquires user information on the user as a target of delivery of the advertisement. For example, the acquisition unit 131 acquires the request for bid from the SSP device 60. For example, the acquisition unit 131 acquires the information on the user attribute of the user as a target of advertisement delivery from the SSP device 60.

Then, the selection unit 232 of the advertisement delivery device 200 selects delivery records corresponding to the user information (Step S202). The selection unit 232 selects, for example, delivery records corresponding to the user attribute. The selection unit 232 then excludes advertisements having insufficient delivery records (Step S203). In FIG. 7, the selection unit 232 excludes the advertisement AC22 having an insufficient delivery record. The selection unit 232 then selects an advertisement based on the evaluation value (Step S204). In FIG. 7, the selection unit 232 selects, based on the eCPM, the advertisement AC23 from the advertisement group CL21 excluding the advertisement AC22.

Then, the transmission unit 133 of the advertisement delivery device 200 submits, as a bid, the advertisement selected by the selection unit 232 (Step S205). In FIG. 7, the transmission unit 133 transmits the information on (such as the bid price for) the advertisement AC23 selected by the selection unit 232 to the SSP device 60.

### B. Modification 2

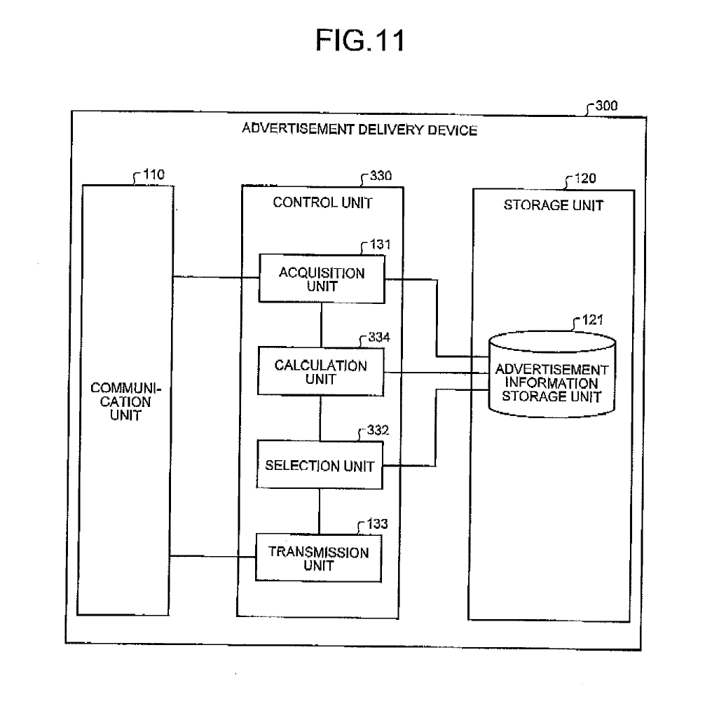

The following describes a case of not excluding the advertisements having insufficient delivery records, using FIGS. 11 to 14. The following illustrates a case in which an advertisement delivery device 300 uses an eCPM calculated using the lower limit value of a confidence interval of the click rate for each advertisement.

i. Configuration of Advertisement Delivery Device

The configuration of the advertisement delivery device 300 according to Modification 2 of the embodiment will first be described using FIG. 11. FIG. 11 is a diagram illustrating a configuration example of the advertisement delivery device 300 according to Modification 2. As illustrated in FIG. 11, the advertisement delivery device 300 includes the communication unit 110, the storage unit 120, and a control unit 330.

The control unit 330 is implemented, for example, by a CPU or an MPU that executes various programs (corresponding to an example of the selection program) stored in a storage device in the advertisement delivery device 300 using a RAM as a work area. Alternatively, the control unit 330 is implemented, for example, by an integrated circuit, such as an ASIC or an FPGA.

As illustrated in FIG. 11, the control unit 330 includes the acquisition unit 131, a calculation unit 334, a selection unit 332, and the transmission unit 133, and implements or executes functions or operations of the selection processing to be described below. The internal configuration of the control unit 330 is not limited to the configuration illustrated in FIG. 11, but may be any other configuration as long as the selection processing to be described below is performed. The connection relation of the processing units included in the control unit 330 is not limited to the connection relation illustrated in FIG. 11, but may be another connection relation.

The calculation unit 334 calculates information on the confidence interval based on the information on the delivery record of each of the advertisements. For example, the calculation unit 334 calculates information on a 95% confidence interval based on the information on the delivery record of each of the advertisements. The calculation unit 334 calculates the information on the 95% confidence interval (hereinafter, simply called the “confidence interval”) of each of the advertisements using a certain conventional technique as appropriate. The calculation unit 334 may calculate the information on the confidence interval using a value, such as 99%, instead of 95%, as appropriate depending on the purpose.

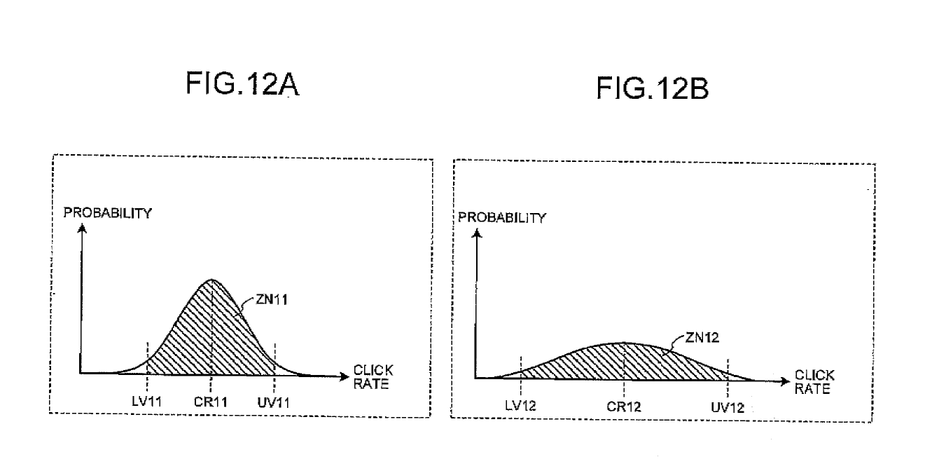

FIGS. 12A and 12B are diagrams illustrating examples of lower limit values according to Modification 2. FIG. 12A illustrates a confidence interval ZN11 for an advertisement having a sufficient number of delivery records. The horizontal axis of the graph illustrated in FIG. 12A represents the click rate, and the vertical axis of the graph represents a probability. A reference value CR11 illustrated in FIG. 12A represents a value (click rate) obtained by dividing the number of times of clicking of the advertisement by the display count of the advertisement. An upper limit value UV11 illustrated in FIG. 12A represents the upper limit value of the confidence interval ZN11, and a lower limit value LV11 illustrated therein represents the lower limit value of the confidence interval ZN11. Each of FIGS. 12A and 12B illustrates the confidence interval of the click rate (CTR) used for calculating the eCPM serving as the evaluation value, but may illustrate the confidence interval of the eCPM serving as the evaluation value. For example, the calculation unit 334 may calculate the confidence interval of the eCPM from the confidence interval of the click rate (CTR).

FIG. 12B illustrates a confidence interval ZN12 for an advertisement having an insufficient number of delivery records. The horizontal axis of the graph illustrated in FIG. 12B represents the click rate, and the vertical axis of the graph represents the probability. A reference value CR12 illustrated in FIG. 12B represents a value (click rate) obtained by dividing the number of times of clicking of the advertisement by the display count of the advertisement. An upper limit value UV12 illustrated in FIG. 12B represents the upper limit value of the confidence interval ZN12, and a lower limit value LV12 illustrated therein represents the lower limit value of the confidence interval ZN12. In this manner, the lower limit value of the advertisement having an insufficient delivery record is smaller than that of the advertisement having a sufficient number of delivery records. Therefore, by being calculated using the lower limit value, the evaluation value is obtained as a value that takes the degree of reliability thereof into account.

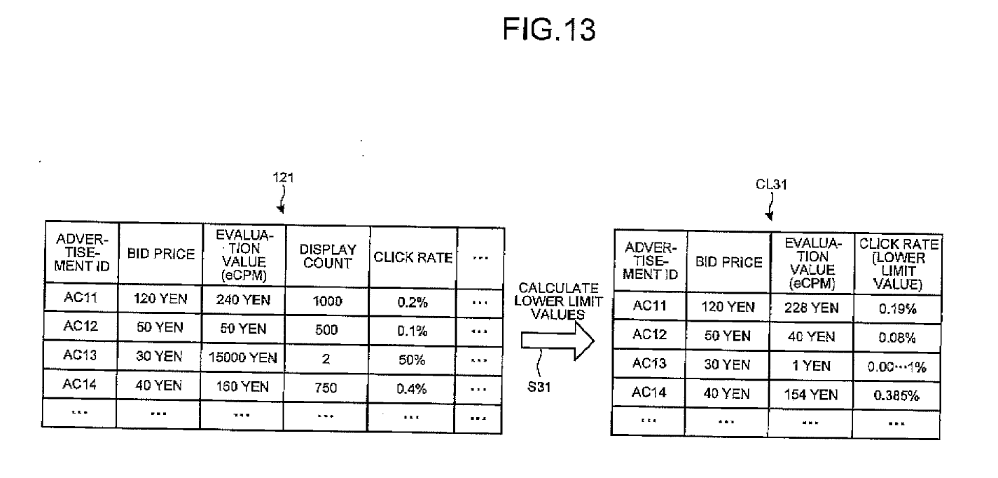

FIG. 13 is a diagram illustrating an example of the calculation of the lower limit values according to Modification 2. In FIG. 13, the calculation unit 334 of the advertisement delivery device 300 calculates the lower limit value of the click rate for each of the advertisements using the information stored in the advertisement information storage unit 121 (Step S31). In FIG. 13, the calculation unit 334 calculates the evaluation value for each of the advertisements using the lower limit value listed in an advertisement group CL31. Specifically, the calculation unit 334 calculates the eCPM serving as the evaluation value of each of the advertisements using the lower limit value listed in the advertisement group CL31.

For example, the calculation unit 334 uses the lower limit value “0.19%” of the click rate for the advertisement AC11 to calculate the eCPM of the advertisement AC11 to be “228 yen.” That is, the calculation unit 334 uses the lower limit value of the click rate for the advertisement AC11 to calculate the eCPM at the lower limit of the confidence interval of the click rate for the advertisement AC11 to be “228 yen.” For example, the calculation unit 334 uses the lower limit value “0.00 . . . 1%” of the click rate for the advertisement AC to calculate the eCPM of the advertisement AC13 to be “1 yen.” That is, the calculation unit 334 uses the lower limit value of the click rate for the advertisement AC13 to calculate the eCPM at the lower limit of the confidence interval of the click rate for the advertisement AC13 to be “1 yen.” In this manner, with regard to an advertisement, such as the advertisement AC13, having an insufficient delivery record, by using a smaller lower limit value, an inappropriate advertisement is unlikely to be selected as an advertisement to be submitted as a bid.

The selection unit 332 selects, from the advertisements, an advertisement to be submitted as a bid in response to the request from the predetermined advertisement delivery platform based on the recorded number of deliveries and the evaluation value for the delivery record of each of the advertisements. For example, the selection unit 332 selects, from the advertisements, the advertisement to be submitted as a bid in response to the request from the SSP device 60 based on the recorded number of deliveries and the eCPM of each of the advertisements. For example, the selection unit 332 selects, from the advertisements, the advertisement to be submitted as a bid in response to the request from the predetermined advertisement delivery platform based on the degree of reliability of the evaluation value.

The selection unit 332 selects, from the advertisements, the advertisement to be submitted as a bid in response to the request from the predetermined advertisement delivery platform based, on the confidence interval of the evaluation value for each of the advertisements derived from the recorded number of deliveries and the degree of reliability of the evaluation value. For example, the selection unit 332 selects, from the advertisements, the advertisement to be submitted as a bid in response to the request from the predetermined advertisement delivery platform based on the lower limit value of the confidence interval for each of the advertisements. In FIG. 13, the selection unit 332 selects the advertisement to be submitted as a bid in response to the request from the predetermined advertisement delivery platform based on the eCPM serving as the evaluation value calculated based on the lower limit value of the click rate for each of the advertisements. In FIG. 13, the selection unit 332 selects the advertisement AC11 having the highest eCPM as the evaluation value, as the advertisement to be submitted as a bid. In this manner, the advertisement delivery device 300 according to Modification 2 can select the advertisement to be submitted as a bid without excluding advertisements having insufficient delivery records. Thereby, the advertisement delivery device 300 can raise the possibility of increasing the delivery record of the advertisements having insufficient delivery records.

ii. Processing Procedure

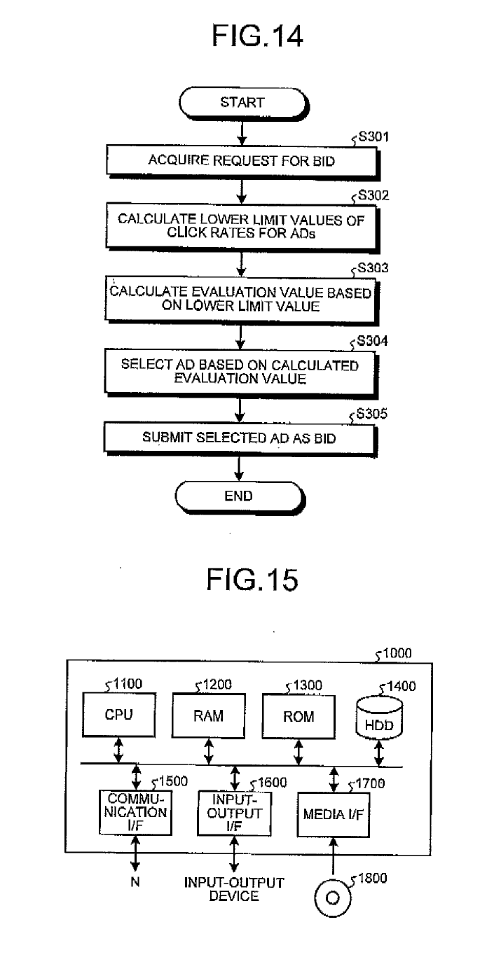

The following describes a procedure of the selection processing by the delivery system 1 according to Modification 2, using FIG. 14. FIG. 14 is a flowchart illustrating an example of the selection processing according to Modification 2.

As illustrated in FIG. 14, the acquisition unit 131 of the advertisement delivery device 300 acquires the request for bid from the predetermined advertisement delivery platform (Step S301). For example, the acquisition unit 131 acquires the request for bid from the SSP device 60.

Then, the calculation unit 334 of the advertisement delivery device 300 calculates the lower limit value of the click rate for each of the advertisements (Step S302). For example, the calculation unit 334 calculates the lower limit value of the 95% confidence interval of the click rate for each of the advertisements. The calculation unit 334 then calculates the evaluation value based on the calculated lower limit value of the click rate (Step S303). For example, the calculation unit 334 calculates the eCPM based on the calculated lower limit value of the click rate.

Then, the selection unit 332 selects the advertisement based on the evaluation value calculated by the calculation unit 334 (Step S304). Then, the transmission unit 133 of the advertisement delivery device 300 submits, as a bid, the advertisement selected by the selection unit 332 (Step S305).

### 6. Effects

As described above, the advertisement delivery device 100 according to the embodiment, the advertisement delivery device 200 according to Modification 1, and the advertisement delivery device 300 according to Modification 2 include the acquisition unit 131, and include the selection units 132, 232, and 332, respectively. The acquisition unit 131 acquires the evaluation values for the delivery records of the advertisements and the information on the degrees of reliability of the evaluation values. Each of the selection units 132, 232, and 332 selects, from the advertisements, the advertisement to be submitted as a bid in response to a request from the predetermined advertisement delivery platform (in the embodiment, the “SSP device 60,” the same applying hereinafter) based on the evaluation value for the delivery record of each of the advertisements and the information on the degree of reliability of the evaluation value.

This allows the advertisement delivery device 100 according to the embodiment, the advertisement delivery device 200 according to Modification 1, and the advertisement delivery device 300 according to Modification 2 to appropriately select the advertisement to be submitted as a bid based on the evaluation value for the delivery record of each of the advertisements and the information on the degree of reliability of the evaluation value. Consequently, the advertisement delivery devices 100, 200, and 300 can raise the possibility of making an expected profit.

In the advertisement delivery device 100 according to the embodiment, the advertisement delivery device 200 according to Modification 1, and the advertisement delivery device 300 according to Modification 2, the selection units 132, 232, and 332 each use the information on the numbers of deliveries of the respective advertisements, the information on the user behaviors in response to the delivered advertisements, or the information on dates and times when the advertisements started to be delivered as the information on the degrees of reliability of the evaluation values so as to select, from the advertisements, the advertisement to be submitted as a bid in response to the request from the predetermined advertisement delivery platform.

This allows each of the advertisement delivery device 100 according to the embodiment, the advertisement delivery device 200 according to Modification 1, and the advertisement delivery device 300 according to Modification 2 to use the information on the numbers of deliveries of the respective advertisements, the information on the user behaviors in response to the delivered advertisements, or the information on dates and times when the advertisements started to be delivered as the information on the degrees of reliability of the evaluation values so as to appropriately select the advertisement to be submitted as a bid. Consequently, the advertisement delivery devices 100, 200, and 300 can raise the possibility of making an expected profit.

The selection unit 332 in the advertisement delivery device 300 according to Modification 2 selects, from the advertisements, the advertisement to be submitted as a bid in response to the request from the predetermined advertisement delivery platform based on the confidence interval of the evaluation value for each of the advertisements derived from the information on the degree of reliability of the evaluation value.

This allows the advertisement delivery device 300 according to Modification 2 to appropriately select the advertisement to be submitted as a bid based on the confidence interval of the evaluation value. Consequently, the advertisement delivery device 300 can raise the possibility of making an expected profit. In this manner, the advertisement delivery device 300 according to Modification 2 can select the advertisement to be submitted as a bid without excluding advertisements having insufficient delivery records.

The selection unit 332 in the advertisement delivery device 300 according to Modification 2 selects, from the advertisements, the advertisement to be submitted as a bid in response to the request from the predetermined advertisement delivery platform based on the lower limit value of the confidence interval for each of the advertisements.

This allows the advertisement delivery device 300 according to Modification 2 to appropriately select the advertisement to be submitted as a bid based on the lower limit value of the confidence interval for each of the advertisements. Consequently, the advertisement delivery device 300 can raise the possibility of making an expected profit. In this manner, the advertisement delivery device 300 according to Modification 2 can select the advertisement to be submitted as a bid without excluding advertisements having insufficient delivery records.

Each of the selection units 132 and 232 in the advertisement delivery device 100 according to the embodiment and the advertisement delivery device 200 according to Modification 1 selects the advertisement to be submitted as a bid in response to the request from the predetermined advertisement delivery platform from the advertisements except advertisements for each of which the information on the degree of reliability of the evaluation value has a value lower than the predetermined threshold.

This allows the advertisement delivery device 100 according to the embodiment and the advertisement delivery device 200 according to Modification 1 to appropriately select the advertisement to be submitted as a bid by excluding the advertisements having insufficient delivery records from candidate advertisements to be submitted as the bid. Consequently, the advertisement delivery devices 100 and 200 can raise the possibility of making an expected profit.

### 7. Hardware Configuration

Each of the advertisement delivery device 100 according to the embodiment, the advertisement delivery device 200 according to Modification 1, and the advertisement delivery device 300 according to Modification 2 described above is constituted by, for example, a computer 1000 having a configuration illustrated in FIG. 15. FIG. 15 is a hardware configuration diagram illustrating an example of the computer for carrying out the functions of the advertisement delivery device. The computer 1000 includes a CPU 1100, a RAM 1200, a read-only memory (ROM) 1300, a hard disk drive (HDD) 1400, a communication interface (I/F) 1500, an input-output interface (I/F) 1600, and a media interface (I/F) 1700.

The CPU 1100 operates based on a program stored in the ROM 1300 or the HDD 1400, and controls various units. The ROM 1300 stores, for example, a boot program to be executed by the CPU 1100 for activating the computer 1000 and a program dependent on the hardware of the computer 1000.

The HDD 1400 stores, for example, a program to be executed by the CPU 1100 and data used by the program. The communication interface 1500 receives data from another device through a network N and transmits the data to the CPU 1100, and transmits data generated by the CPU 1100 to the other device through the network N.

The CPU 1100 controls output devices, such as a display and a printer, and input devices, such as a keyboard and a mouse, through the input-output interface 1600. The CPU 1100 acquires data from the input devices through the input-output interface 1600. The CPU 1100 outputs the generated data to the output devices through the input-output interface 1600.

The media interface 1700 reads programs or data stored in a recording medium 1800, and provides the programs or data to the CPU 1100 through the RAM 1200. The CPU 1100 loads the programs from the recording medium 1800 into the RAM 1200 through the media interface 1700, and executes the loaded programs. The recording medium 1800 is, for example, an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, when the computer 1000 serves as the advertisement delivery device 100, 200, or 300, the CPU 1100 of the computer 1000 performs the function of the control unit 130, 230, or 330 by executing the program loaded in the RAM 1200. The CPU 1100 of the computer 1000 reads the programs from the recording medium 1800 and executes the programs. As another example, however, the CPU 1100 may acquire the programs from another device through the network N.

While the above has described the embodiment and the modifications thereof according to the present application based on the drawings, the embodiment and the modifications thereof are merely examples. The broad inventive principles can be embodied in other embodiments including various modifications or improvements based on the knowledge of person skilled in the art, including the aspects described in the disclosure.

### 8. Other

Of the processes described in the embodiment and the modifications thereof given above, all or part of the processes explained as being automatically performed can be manually performed, and all or part of the processes explained as being manually performed can be automatically performed with a known method. In addition, the information, including the processing procedure, the specific names, the various types of data and parameters, illustrated in the document and the drawings above can be changed in any desired way unless otherwise specified. For example, the various types of information illustrated in the drawings are not limited to the information illustrated in the drawings.

The components of the devices illustrated in the drawings are functionally conceptual, and need not be physically configured as illustrated in the drawings. In other words, the specific modes of distribution and integration of the devices are not limited to those illustrated in the drawings, and all or part thereof can be functionally or physically distributed or integrated in any desired units according to various kinds of load and conditions of use.

The embodiment and the modifications thereof described above can be appropriately combined together unless the processing details contradict each other.

The term “unit,” “section,” or “module” used above can be replaced with the term “means,” “circuit” or the like. For example, the acquisition unit can be referred to as the acquisition means or the acquisition circuit.

According to an aspect of the embodiment, an effect is produced in which an advertisement to be submitted as a bid can be appropriately selected.

The appended claims need not be limited to the disclosed, embodiments and should be construed as embodying all modifications and alternative constructions that may occur to one skilled in the art that fairly fall within the basic teaching herein set forth.

1-7. (canceled)

8. A digital media delivery device that selects digital media for display within digital content on a terminal device based on a degree of reliability of an evaluation value for the digital media, the digital media delivery device comprising:
a network interface;
a memory that stores digital media information for a plurality of items of digital media, the digital media information for each item of digital media including:
an evaluation value; and
a degree of reliability that reflects the reliability of the evaluation value; and
a processor operatively connected to the network interface and the memory, the processor being programmed to:
receive a request for digital media for display within digital content on the terminal device via the network interface;
select an item of digital media from the plurality of items of digital media, based on the evaluation value for the delivery records of each of the plurality of items of digital media and the information on the degrees of reliability of the evaluation value; and
transmit an identification of the selected item of digital media via the network interface in response to the request.

9. The digital media delivery device according to claim 8, wherein the degree of reliability includes at least one of the following:
information on a number of past deliveries of the corresponding digital media;
information on user behavior in response to past deliveries of the corresponding digital media; and
information on dates and times when the corresponding digital media started to be delivered.

10. The digital media delivery device according to claim 9, wherein the processor is programmed to:
select, from the plurality of items of digital media, the item of digital media to be submitted as a bid in response to the request from the predetermined digital media delivery platform based on confidence interval of the evaluation value for the each of the plurality of items of digital media derived from the information on the degrees of reliability of the evaluation value.

11. The digital media delivery device according to claim 10, wherein the processor is programmed to:
select, from the plurality of items of digital media, the item of digital media to be submitted as a bid in response to the request from the predetermined digital media delivery platform based on lower limit value of the confidence interval for the each of the plurality of items of digital media.

12. The digital media delivery device according to claim 10, wherein the processor is programmed to:
select the item of digital media to be submitted as a bid in response to the request from the predetermined digital media delivery platform, from the plurality of items of digital media except items of digital media for which the information on the degrees of reliability of the evaluation value has value lower than a predetermined threshold.

13. The digital media delivery device according to claim 8, wherein:
the digital media information for each item of digital media includes:
for a first demographic, a first evaluation value and a first a degree of reliability that reflects the reliability of the first evaluation value; and
for a second demographic, a second evaluation value and a second degree of reliability that reflects the reliability of the second evaluation value;
the received request includes a target demographic; and
the processor is programmed to select either (i) the first evaluation value and the first degree of reliability or (ii) the second evaluation value and the second a degree of reliability when selecting the item of digital media based on the target demographic.

14. A digital media delivery method that selects digital media for display within digital content on a terminal device based on a degree of reliability of an evaluation value for the digital media, the digital media delivery device, the method comprising:
accessing a memory that stores digital media information for a plurality of items of digital media, the digital media information for each item of digital media including:
an evaluation value; and
a degree of reliability that reflects the reliability of the evaluation value;
receiving a request for digital media for display within digital content on the terminal device via the network interface;
selecting an item of digital media from the plurality of items of digital media, based on the evaluation value for the delivery records of each of the plurality of items of digital media and the information on the degrees of reliability of the evaluation value; and
transmitting an identification of the selected item of digital media via the network interface in response to the request.

15. A computer-readable storage medium having stored therein a digital media delivery program that selects digital media for display within digital content on a terminal device based on a degree of reliability of an evaluation value for the digital media, the digital media delivery device, the program causing a computer to execute a process comprising:
accessing a memory that stores digital media information for a plurality of items of digital media, the digital media information for each item of digital media including:
an evaluation value; and
a degree of reliability that reflects the reliability of the evaluation value;
receiving a request for digital media for display within digital content on the terminal device via the network interface;
selecting an item of digital media from the plurality of items of digital media, based on the evaluation value for the delivery records of each of the plurality of items of digital media and the information on the degrees of reliability of the evaluation value; and
transmitting an identification of the selected item of digital media via the network interface in response to the request.
